(19) United States
(12) Patent Application Publication
(10) Pub. No.: US 2025/0227656 A1
(43) Pub. Date: Jul. 10, 2025

(54) TECHNIQUES FOR SIDELINK POWER CONTROL FOR POSITIONING REFERENCE SIGNAL TRANSMISSION

(71) Applicant: Lenovo (Singapore) Pte. Ltd., Singapore (SG)

(72) Inventors: Robin Rajan Thomas, Bad Nauheim (DE); Abir Ben Hadj Fredj, Frankfurt am Main (DE); Karthikeyan Ganesan, Kronberg im Taunus (DE)

(21) Appl. No.: 18/853,106

(22) PCT Filed: Mar. 31, 2023
(86) PCT No.: PCT/IB2023/053271

§ 371 Date: Sep. 30, 2024

Related U.S. Application Data
(60) Provisional application No. 63/325,944, filed on Mar. 31, 2022.

(51) Int. Cl. H04W 64/00; H04B 17/318; H04W 52/32

(52) U.S. Cl. CPC H04W 64/003; H04B 17/328; H04W 52/325

(57) ABSTRACT

Various aspects of the present disclosure relate to techniques for SL power control for PRS transmission. An apparatus is configured to receive a configuration for adapting a transmit power of a SL PRS transmission for a responder device, receive a reported RSS measurement from the responder device, and adapt the SL PRS transmit power for the responder device based on the received configuration and the RSS measurement.

### CROSS-REFERENCE TO RELATED APPLICATIONS

This application claims the benefit of U.S. Provisional Patent Application No. 63/325,944 entitled “SIDELINK POWER CONTROL FOR POSITIONING REFERENCE SIGNAL TRANSMISSION” and filed on Mar. 31, 2022, for Robin Rajan Thomas, et al., which is incorporated herein by reference.

### FIELD

The subject matter disclosed herein relates generally to wireless communications and more particularly relates to techniques for sidelink (“SL”) power control for positioning reference signal (“PRS”) transmission.

### BACKGROUND

A wireless communications system may include one or multiple network communication devices, such as base stations, which may be otherwise known as an eNodeB (“eNB”), a next-generation NodeB (“gNB”), or other suitable terminology. Each network communication devices, such as a base station may support wireless communications for one or multiple user communication devices, which may be otherwise known as user equipment (“UE”), or other suitable terminology. The wireless communications system may support wireless communications with one or multiple user communication devices by utilizing resources of the wireless communication system (e.g., time resources such as symbols, slots, subframes, frames, or the like, or frequency resources such as subcarriers, carriers, or the like. Additionally, the wireless communications system may support wireless communications across various radio access technologies including third generation (“3G”) radio access technology, fourth generation (“4G”) radio access technology, fifth generation (“5G”) radio access technology, among other suitable radio access technologies beyond 5G (e.g., sixth generation (“6G”)). In the wireless communications system, one or more of the network communication devices (e.g., base stations) or the user communication devices (e.g., UEs) may support one or multiple CG configurations for wireless communications (e.g., downlink communications, uplink communications).

### BRIEF SUMMARY

Disclosed are procedures for techniques for SL power control for PRS transmission. The procedures may be implemented by apparatus, systems, methods, or computer program products.

In one embodiment, a first apparatus includes a processor and a memory coupled to the processor. In one embodiment, the memory includes instructions that are executable by the processor to cause the apparatus to receive a configuration for adapting a transmit power of a SL PRS transmission for a responder device, receive a reported RSS measurement from the responder device, and adapt the SL PRS transmit power for the responder device based on the received configuration and the RSS measurement.

In one embodiment, a first method receives a configuration for adapting a transmit power of a SL PRS transmission for a responder device, receives a reported RSS measurement from the responder device, and adapts the SL PRS transmit power for the responder device based on the received configuration and the RSS measurement.

In one embodiment, a second apparatus includes a processor and a memory coupled to the processor. In one embodiment, the memory includes instructions that are executable by the processor to cause the apparatus to receive, from an initiator device, signal assistance information comprising at least a SL PRS transmit power, compute the SL PRS transmit power based at least in part on the received signal assistance information and determines a SL PRS RSS measurement, and transmit a report comprising the SL PRS RSS measurement to the initiator device for adapting the SL PRS transmit power of the initiator device.

In one embodiment, a second method receives, from an initiator device, signal assistance information comprising at least a SL PRS transmit power. In one embodiment, the second method computes the SL PRS transmit power based at least in part on the received signal assistance information and determines a SL PRS RSS measurement. In one embodiment, the second method transmits a report comprising the SL PRS RSS measurement to the initiator device for adapting the SL PRS transmit power of the initiator device.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 illustrates an example of a wireless communications system that supports techniques for SL power control for PRS transmission in accordance with aspects of the present disclosure;

FIG. 2 illustrates an example of a 5G New Radio (“NR”) protocol stack that supports techniques for SL power control for PRS transmission in accordance with aspects of the present disclosure;

FIG. 3 illustrates an example of absolute and relative positioning that supports techniques for SL power control for PRS transmission in accordance with aspects of the present disclosure;

FIG. 4 illustrates an example of a Multi-Cell round trip time (“RTT”) procedure that supports techniques for SL power control for PRS transmission in accordance with aspects of the present disclosure;

FIG. 5 illustrates an example of relative range estimation that supports techniques for SL power control for PRS transmission in accordance with aspects of the present disclosure;

FIG. 6 illustrates an example of NR Beam-based positioning that supports techniques for SL power control for PRS transmission in accordance with aspects of the present disclosure;

FIG. 7 illustrates an example of an LPP RequestLocationInformation message that supports techniques for SL power control for PRS transmission in accordance with aspects of the present disclosure;

FIG. 8 illustrates an example of an LPP ProvideLocationInformation message that supports techniques for SL power control for PRS transmission in accordance with aspects of the present disclosure;

FIG. 9A illustrates an example of adaptive SL transmission (“Tx”) power for SL PRS that supports techniques for SL power control for PRS transmission in accordance with aspects of the present disclosure;

FIG. 9B illustrates an example of adaptive SL PRS Tx power that supports techniques for SL power control for PRS transmission in accordance with aspects of the present disclosure;

FIG. 9C illustrates another example of adaptive SL PRS Tx power that supports techniques for SL power control for PRS transmission in accordance with aspects of the present disclosure;

FIG. 10A illustrates an example of muting configurations for groupcast SL positioning that supports techniques for SL power control for PRS transmission in accordance with aspects of the present disclosure;

FIG. 10B illustrates another example of muting configurations for separate unicast SL positioning/ranging sessions that support techniques for SL power control for PRS transmission in accordance with aspects of the present disclosure;

FIG. 11 illustrates an example of a UE apparatus that supports techniques for SL power control for PRS transmission in accordance with aspects of the present disclosure;

FIG. 12 illustrates an example of a network equipment (“NE”) apparatus that supports techniques for SL power control for PRS transmission in accordance with aspects of the present disclosure;

FIG. 13 illustrates a flowchart of a method that supports techniques for SL power control for PRS transmission in accordance with aspects of the present disclosure; and

FIG. 14 illustrates a flowchart of a method that supports techniques for SL power control for PRS transmission in accordance with aspects of the present disclosure.

### DETAILED DESCRIPTION

Generally, the present disclosure describes systems, methods, and apparatuses for techniques for SL power control for PRS transmission. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Although there exists a Third Generation Partnership Project (“3GPP”) positioning framework, which enables UE-assisted and UE-based positioning methods, there is currently a lack of support for efficient UE-to-UE range/orientation determination, which supports relative positioning applications across different vertical services, e.g., vehicle to everything (“V2X”), public safety, industrial internet of things (“IIoT”), commercial, and/or the like.

In the case of SL positioning, timely and accurate measurements are essential to obtain high absolute and relative positioning accuracy. Several issues make SL positioning different from traditional positioning: moving and distributed nodes, varying mobility, availability of anchor and non-anchor nodes, uncertainty, and so on. At the same time, SL positioning provides advantages in terms of range and orientation estimation, which is essential for tracking and position estimation for UEs in V2X, Public safety, IIoT, and commercial scenarios.

For traditional Uu positioning frameworks, transmit power boosting and muting have been employed to manage interference of multiple downlink positioning reference signals transmitted by various anchor nodes (base stations). In the case of SL communications, the power control mechanism is based on an open loop control mechanism for both unicast and groupcast communications. In the case of SL PRS transmissions, it is important that the SL PRS be detectable at the responder device with a good degree of accuracy while not causing interference with other SL/UL data and other PRS transmissions. Therefore, suitable SL power control procedures need to be implemented within a framework for the transmission of SL PRS.

In one embodiment, this disclosure presents systems, apparatuses and methods that detail the power control enhancements required to transmit SL PRS, which may vary depending on the type of transmitted PRS signals. In one embodiment, the initiator device or anchor device may utilize the computed or configured downlink (“DL”) and/or SL path loss reference to control the SL PRS transmit power. In another embodiment, multiple anchor devices may each adapt the SL PRS transmit power, while also providing assistance information to the responder device to enable power control of the reply SL PRS signal.

In another embodiment, a muting configuration and corresponding behavior is detailed such that the ability to hear the SL PRS is not impacted by nearby anchor devices. In another embodiment, a method to configure and adapt the SL PRS transmission power for many-to-one and one-to-many (groupcast) SL positioning methods are described, which also includes methods for the responder device to adapt the SL PRS transmit power based on additional assistance information provided by the initiator/anchor device.

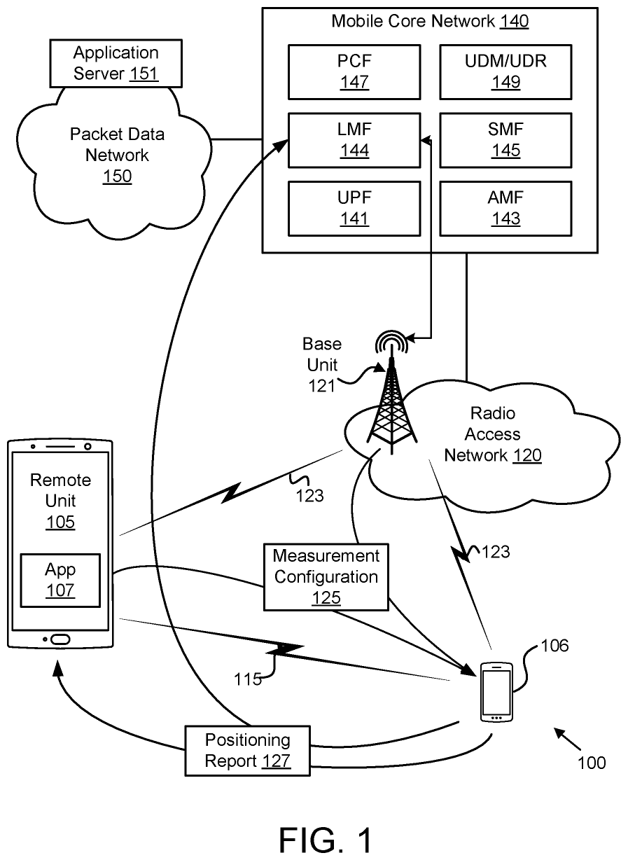

FIG. 1 illustrates an example of a wireless communications system that supports techniques for SL power control for PRS transmission in accordance with aspects of the present disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the 5G system specified in the 3GPP specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and DL communication signals. Furthermore, the UL and DL communication signals may be carried over the wireless communication links 123. Here, the RAN 120 is an intermediate network that provides the remote units 105 with access to the mobile core network 140. As described in greater detail below, the base unit(s) 121 may provide a cell operating using a first frequency range and/or a cell operating using a second frequency range.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

To establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, e.g., a tunnel between the remote unit 105 and a Packet Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, abase station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121. Note that during NR operation on unlicensed spectrum (referred to as “NR-U”), the base unit 121 and the remote unit 105 communicate over unlicensed (e.g., shared) radio spectrum.

In one embodiment, the mobile core network 140 is a 5GC or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Location Management Function (“LMF”) 144, a Unified Data Management function (“UDM””) and a User Data Repository (“UDR”). Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (DN), in the 5G architecture. The AMF 143 is responsible for termination of NAS signaling, NAS ciphering & integrity protection, registration management, connection management, mobility management, access authentication and authorization, security context management. The SMF 145 is responsible for session management (e.g., session establishment, modification, release), remote unit (e.g., UE) IP address allocation & management, DL data notification, and traffic steering configuration of the UPF 141 for proper traffic routing.

The LMF 144 receives positioning measurements or estimates from RAN 120 and the remote unit 105 (e.g., via the AMF 143) and computes the position of the remote unit 105. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In various embodiments, the mobile core network 140 may also include a Policy Control Function (“PCF”) (which provides policy rules to CP functions), a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

In one embodiment, the remote unit 105 may be an initiator device and transmits a positioning measurement configuration 125 to a responder device 106. In some embodiments, the initiator device may be a base unit 121, e.g., a gNB. In one embodiment, the initiator device receives a positioning/measurement report 127 from the responder device 106. In one embodiment, the initiator device sends the measurement configuration, and/or other configurations, and receives the positioning report 127 over a SL connection 115 between the initiator device and the responder device 106. As used herein, a SL connection 115 allows remote units 105 to communicate directly with each other (e.g., device-to-device communication) using SL (e.g., V2X communication) signals.

While FIG. 1 depicts components of a 5G RAN and a 5G core network, the described embodiments for techniques for SL power control for PRS transmission apply to other types of communication networks and RATs, including IEEE 802.11 variants, Global System for Mobile Communications (“GSM”, e.g., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station but it is replaceable by any other radio access node, e.g., gNB, ng-eNB, eNB, Base Station (“BS”), Access Point (“AP”), etc. Further, the operations are described mainly in the context of 5G NR. However, the proposed solutions/methods are also equally applicable to other mobile communication systems supporting techniques for SL power control for PRS transmission.

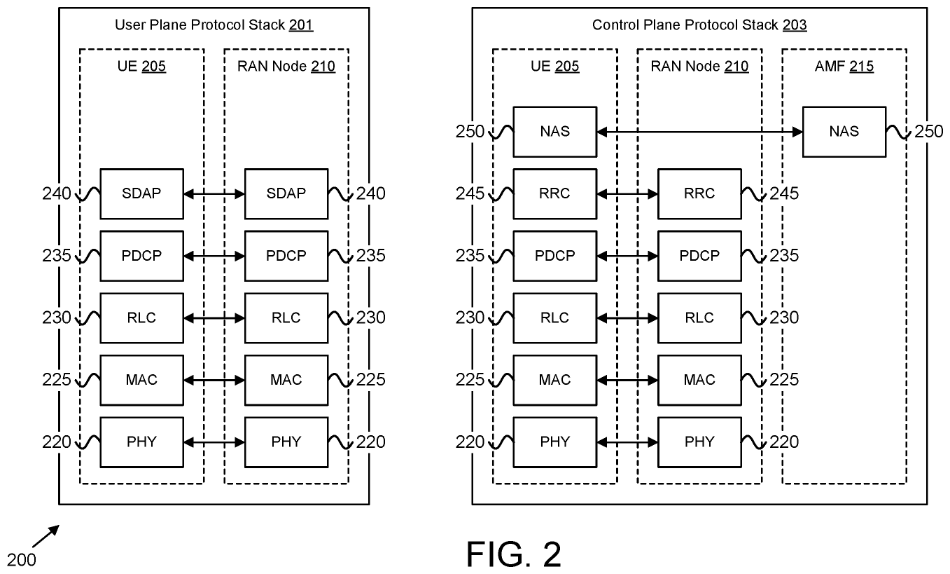

illustrates an example of a 5G NR protocol stack that supports techniques for SL power control for PRS transmission in accordance with aspects of the present disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a physical layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer (also referred to as “AS protocol stack”) for the User Plane protocol stack 201 consists of at least SDAP, PDCP, RLC and MAC sublayers, and the physical layer. The AS layer for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 245 and the NAS layer 250 for the control plane and includes, e.g., an Internet Protocol (“IP”) layer and/or PDU Layer (not depicted) for the user plane. L1 and L2 are referred to as “lower layers,” while L3 and above (e.g., transport layer, application layer) are referred to as “higher layers” or “upper layers.”

The physical layer 220 offers transport channels to the MAC sublayer 225. The physical layer 220 may perform a Clear Channel Assessment and/or Listen-Before-Talk (“CCA/LBT”) procedure using energy detection thresholds, as described herein. In certain embodiments, the physical layer 220 may send a notification of UL Listen-Before-Talk (“LBT”) failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and the 5GC 215. NAS messages are passed transparently through the RAN. The NAS layer 250 is used to manage the establishment of communication sessions and for maintaining continuous communications with the UE 205 as it moves between different cells of the RAN. In contrast, the AS layer is between the UE 205 and the RAN (e.g., RAN node 210) and carries information over the wireless portion of the network.

As background, NR positioning based on NR Uu signals and standalone access (“SA”) architecture (e.g., beam-based transmissions) is specified in Rel-16. The target use cases also included commercial and regulatory (e.g., emergency services) scenarios, as in Rel-15. The performance requirements are the following (e.g., from TR 38.855):

TABLE 1
Rel. 16 Positioning Performance Requirements

| Positioning | | |
|---|---|---|
| Error | Indoor | Outdoor |
| Horizontal | <3 m for 80% | <10 m for 80% |
| Positioning | of UEs | of UEs |
| Vertical | <3 m for 80% | <3 m for 80% |
| Positioning | of UEs | of UEs |

3GPP Rel-17 positioning defines the positioning performance requirements for commercial and IIoT use cases as follows (e.g., from TR 38.857):

TABLE 2
Rel. 17 Positioning Performance Requirements

| Positioning | | |
|---|---|---|
| Error | Commercial | IIOT |
| Horizontal | (<1 m) for 90% of | (<0.2 m) for 90% of |
| Positioning | UEs | UEs; |
| Vertical | (<3 m) for 90% of | (<1 m) for 90% of |
| Positioning | UEs | UEs |
| Physical layer | (<10 ms) | (<10 ms) |
| latency for position | | |
| estimation of UE | | |
| End-to-End | (<100 ms) | (<100 ms, in the |
| Latency for position | | order of 10 ms is desired) |
| estimation of UE | | |

Some UE positioning techniques supported in Rel-16 are listed in Table 3. The separate positioning techniques as indicated in Table 3 may be currently configured and performed based on the requirements of the LMF and/or UE capabilities. Note that Table 3 includes Terrestrial Beacon System (“TBS”) positioning based on PRS signals, but only observed time difference of arrival (“OTDOA”) based on LTE signals is supported. The E-CID includes Cell-ID for NR method. The TBS method refers to TBS positioning based on Metropolitan Beacon System (“MBS”) signals.

TABLE 3
Gunnarted Rel_16 TIF nacitinning methode

| | | UE- | NG- | |
|---|---|---|---|---|
| | UE- | assisted, | RAN node | Secure User Plane |
| Method | based | LMF-based | assisted | Location (“SUPL”) |
| A-GNSS | Yes | Yes | No | Yes (UE-based and UE- |
| | | | | assisted) |
| OTDOA | No | Yes | No | Yes (UE-assisted) |
| E-CID | No | Yes | Yes | Yes for E-UTRA (UE- |
| | | | | assisted) |
| Sensor | Yes | Yes | No | No |
| WLAN | Yes | Yes | No | Yes |
| Bluetooth | No | Yes | No | No |
| TBS | Yes | Yes | No | Yes (MBS) |
| DL- | Yes | Yes | No | No |
| TDOA | | | | |
| DL-AOD | Yes | Yes | No | No |
| Multi- | No | Yes | Yes | No |
| RTT | | | | |
| NR E- | No | Yes | FFS | No |
| CID | | | | |
| UL- | No | No | Yes | No |
| TDOA | | | | |
| UL-AoA | No | No | Yes | No |

The transmission of PRS enable the UE to perform UE positioning-related measurements to enable the computation of a UE's location estimate and are configured per Transmission Reception Point (“TRP”), where a TRP may transmit one or more beams.

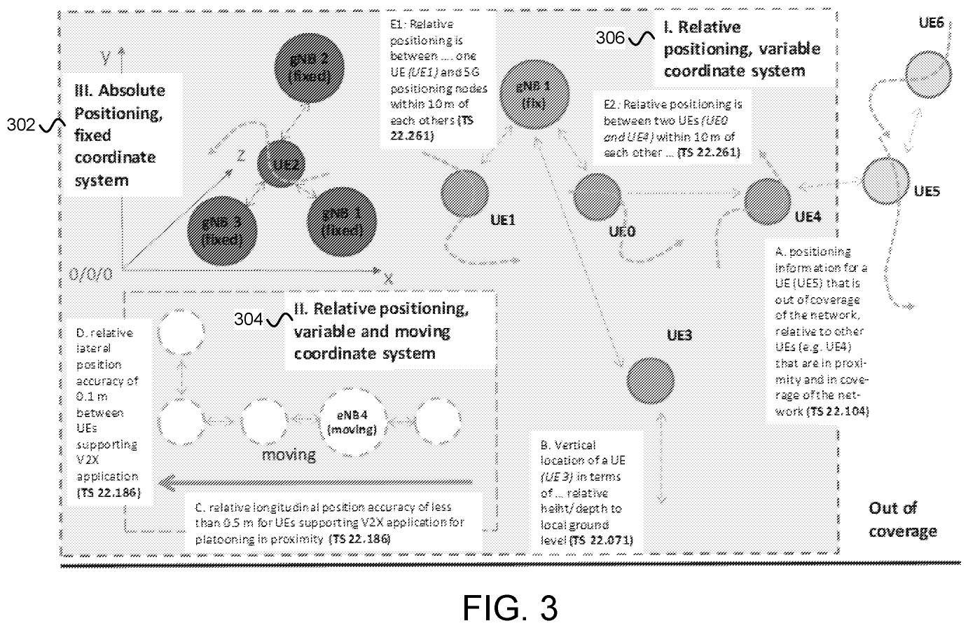

FIG. 3 illustrates an example of absolute and relative positioning that supports techniques for SL power control for PRS transmission in accordance with aspects of the present disclosure. In particular, FIG. 3 depicts an overview of one embodiment of the absolute and relative positioning scenarios as defined in the architectural (stage 1) specifications using three different co-ordinate systems: Absolute Positioning, fixed coordinate systems 302; Relative Positioning, variable and moving coordinate system 304; and Relative Positioning, variable coordinate system 306.

In one embodiment, the following RAT-dependent positioning techniques may be supported by the system 100:

DL-TDoA: The downlink time difference of arrival (“DL-TDOA”) positioning method makes use of the DL RS Time Difference (“RSTD”) (and optionally DL PRS RS Received Power (“RSRP”) of DL PRS RS Received Quality (“RSRQ”)) of downlink signals received from multiple TPs, at the UE (e.g., remote unit 105). The UE measures the DL RSTD (and optionally DL PRS RSRP) of the received signals using assistance data received from the positioning server, and the resulting measurements are used along with other configuration information to locate the UE in relation to the neighboring Transmission Points (“TPs”).

DL-AoD: The DL Angle of Departure (“AoD”) positioning method makes use of the measured DL PRS RSRP of downlink signals received from multiple TPs, at the UE. The UE measures the DL PRS RSRP of the received signals using assistance data received from the positioning server, and the resulting measurements are used along with other configuration information to locate the UE in relation to the neighboring TPs.

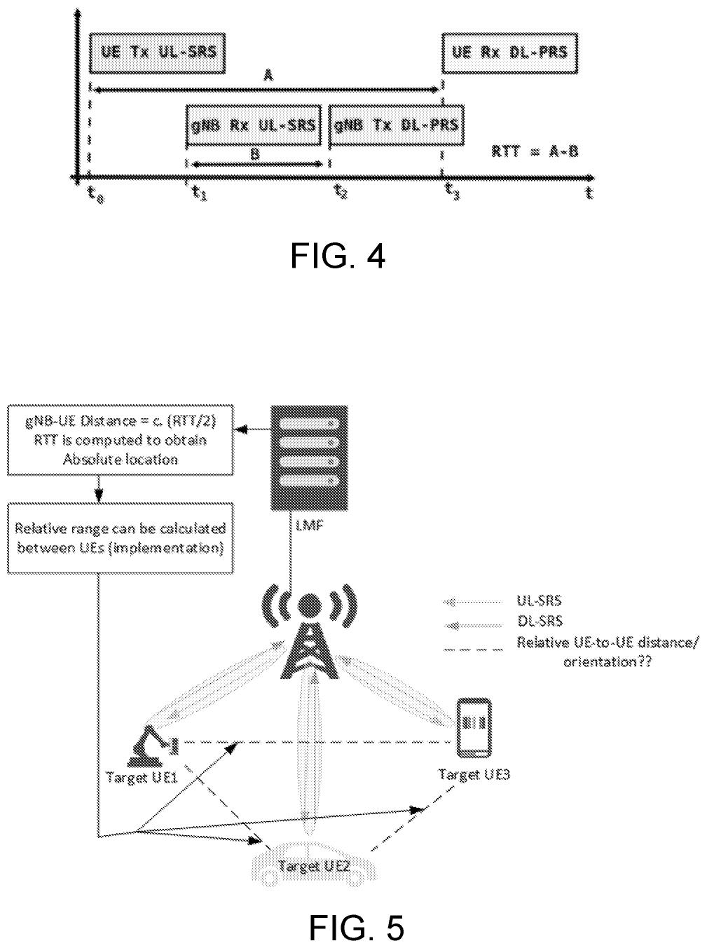

Multi-RTT: The Multiple-Round Trip Time (“Multi-RTT”) positioning method makes use of the UE Receive-Transmit (“Rx-Tx”) measurements and DL PRS RSRP of downlink signals received from multiple TRPs, measured by the UE and the gNB Rx-Tx measurements (e.g., measured by RAN node) and UL SRS-RSRP at multiple TRPs of uplink signals transmitted from UE, as shown in FIG. 4, which illustrates an example of a Multi-Cell round trip time (“RTT”) procedure that supports techniques for SL power control for PRS transmission in accordance with aspects of the present disclosure.

FIG. 5 illustrates an example of relative range estimation that supports techniques for SL power control for PRS transmission in accordance with aspects of the present disclosure. As shown in FIG. 5, the UE measures the UE Rx-Tx measurements (and optionally DL PRS RSRP of the received signals) using assistance data received from the positioning server, and the TRPs measure the gNB Rx-Tx measurements (and optionally UL SRS-RSRP of the received signals) using assistance data received from the positioning server. The measurements are used to determine the Round Trip Time (“RTT”) at the positioning server which are used to estimate the location of the UE. In one embodiment, Multi-RTT is only supported for UE-assisted/NG-RAN assisted positioning techniques, as noted in Table 3.

E-CID/NR E-CID: Enhanced Cell ID (“CID”) positioning method, the position of a UE is estimated with the knowledge of its serving ng-eNB, gNB and cell and is based on LTE signals. The information about the serving ng-eNB, gNB and cell may be obtained by paging, registration, or other methods. NR Enhanced Cell ID (“NR E-CID”) positioning refers to techniques which use additional UE measurements and/or NR radio resource and other measurements to improve the UE location estimate using NR signals.

Although NR E-CID positioning may utilize some of the same measurements as the measurement control system in the RRC protocol, the UE generally is not expected to make additional measurements for the sole purpose of positioning; e.g., the positioning procedures do not supply a measurement configuration or measurement control message, and the UE reports the measurements that it has available rather than being required to take additional measurement actions.

UL-TDoA: The UL TDOA positioning method makes use of the UL TDOA (and optionally UL SRS-RSRP) at multiple reception points (“RPs”) of uplink signals transmitted from the UE. The RPs measure the UL TDOA (and optionally UL SRS-RSRP) of the received signals using assistance data received from the positioning server, and the resulting measurements are used along with other configuration information to estimate the location of the UE.

UL-AoA: The UL Angle of Arrival (“AoA”) positioning method makes use of the measured azimuth and the zenith angles of arrival at multiple RPs of uplink signals transmitted from the UE. The RPs measure A-AoA and Z-AoA of the received signals using assistance data received from the positioning server, and the resulting measurements are used along with other configuration information to estimate the location of the UE.

In one embodiment, the following RAT-independent positioning techniques may be supported by the system 100:

Network-assisted GNSS methods: these methods make use of UEs that are equipped with radio receivers capable of receiving GNSS signals. In 3GPP specifications the term GNSS encompasses both global and regional/augmentation navigation satellite systems. Examples of global navigation satellite systems include GPS, Modernized GPS, Galileo, GLONASS, and BeiDou Navigation Satellite System (“BDS”). Regional navigation satellite systems include Quasi Zenith Satellite System (“QZSS”) while the many augmentation systems, are classified under the generic term of Space Based Augmentation Systems (“SBAS”) and provide regional augmentation services. In this concept, different GNSSs (e.g. GPS, Galileo, etc.) can be used separately or in combination to determine the location of a UE.

Barometric pressure sensor positioning: the barometric pressure sensor method makes use of barometric sensors to determine the vertical component of the position of the UE. The UE measures barometric pressure, optionally aided by assistance data, to calculate the vertical component of its location or to send measurements to the positioning server for position calculation. This method should be combined with other positioning methods to determine the 3D position of the UE.

WLAN positioning: the WLAN positioning method makes use of the WLAN measurements (AP identifiers and optionally other measurements) and databases to determine the location of the UE. The UE measures received signals from WLAN access points, optionally aided by assistance data, to send measurements to the positioning server for position calculation. Using the measurement results and a references database, the location of the UE is calculated. Alternatively, the UE makes use of WLAN measurements and optionally WLAN AP assistance data provided by the positioning server, to determine its location.

Bluetooth positioning: the Bluetooth positioning method makes use of Bluetooth measurements (beacon identifiers and optionally other measurements) to determine the location of the UE. The UE measures received signals from Bluetooth beacons. Using the measurement results and a references database, the location of the UE is calculated. The Bluetooth methods may be combined with other positioning methods (e.g. WLAN) to improve positioning accuracy of the UE.

TBS positioning: a TBS consists of a network of ground-based transmitters, broadcasting signals only for positioning purposes. The current type of TBS positioning signals are the MBS signals and PRS signals. The UE measures received TBS signals, optionally aided by assistance data, to calculate its location or to send measurements to the positioning server for position calculation.

Motion sensor positioning: the motion sensor method makes use of different sensors such as accelerometers, gyros, magnetometers, to calculate the displacement of UE. The UE estimates a relative displacement based upon a reference position and/or reference time. UE sends a report comprising the determined relative displacement which can be used to determine the absolute position. This method should be used with other positioning methods for hybrid positioning.

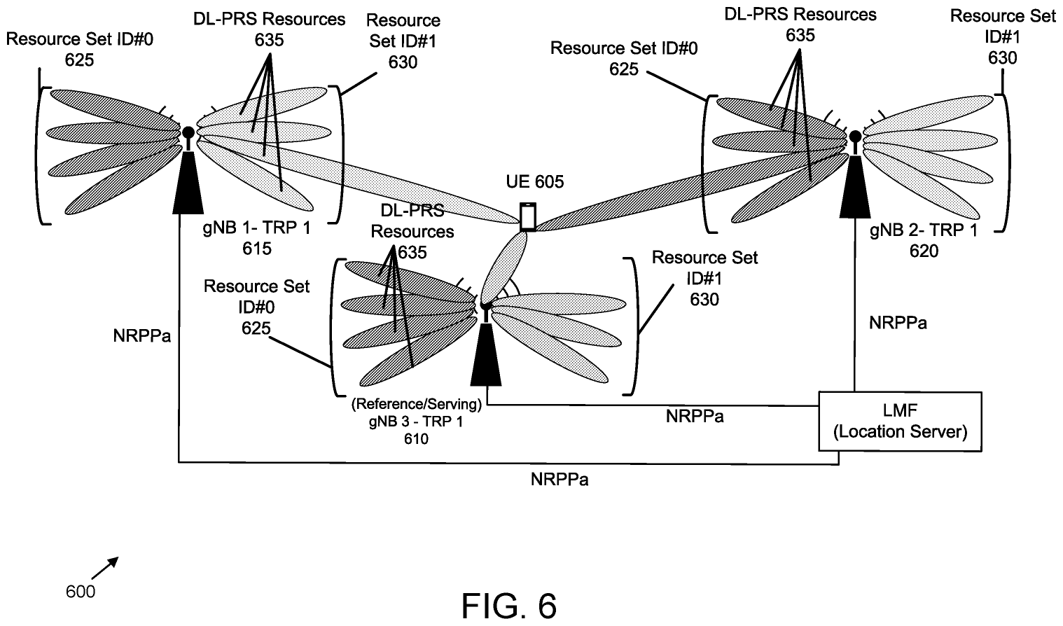

FIG. 6 illustrates an example of NR Beam-based positioning that supports techniques for SL power control for PRS transmission in accordance with aspects of the present disclosure. In particular, FIG. 6 depicts a system 600 for NR beam-based positioning. According to Rel-16, the PRS can be transmitted by different base stations (serving and neighboring) using narrow beams over Frequency Range #1 Between (“FR1”, e.g., frequencies from 410 MHz to 7125 MHz) and Frequency Range #2 (“FR2”, e.g., frequencies from 24.25 GHz to 52.6 GHz), which is relatively different when compared to LTE where the PRS was transmitted across the whole cell.

As illustrated in FIG. 6, a UE 605 may receive PRS from a first gNB (“gNB 3”) 610, which is a serving gNB, and also from a neighboring second gNB (“gNB 1”) 615, and a neighboring third gNB (“gNB 2”) 620. Here, the PRS can be locally associated with a set of PRS Resources grouped under a Resource Set ID for a base station (e.g., TRP). In the depicted embodiments, each gNB 610, 615, 620 is configured with a first Resource Set ID 625 and a second Resource Set ID 630. As depicted, the UE 605 receives PRS on transmission beams; here, receiving PRS from the gNB 3 610 on a set of PRS Resources 635 from the second Resource Set ID 630, receiving PRS from the gNB 1 615 on a set of PRS Resources 635 from the second Resource Set ID 630, and receiving PRS from the gNB 2 620 on a set of PRS Resources 635 from the first Resource Set ID 625.

Similarly, UE positioning measurements such as Reference Signal Time Difference (“RSTD”) and PRS RSRP measurements are made between beams as opposed to different cells as was the case in LTE. In addition, there are additional UL positioning methods for the network to exploit to compute the target UE's location. Table 4 lists the RS-to-measurements mapping required for each of the supported RAT-dependent positioning techniques at the UE, and Table 5 lists the RS-to-measurements mapping required for each of the supported RAT-dependent positioning techniques at the gNB.

TABLE 4
UE Measurements to enable RAT-dependent positioning techniques

| | | To facilitate |
|---|---|---|
| DL/UL Reference | | support of the following |
| Signals | UE Measurements | positioning techniques |
| Rel-16 DL PRS | DL RSTD | DL-TDOA |
| Rel-16 DL PRS | DL PRS RSRP | DL-TDOA, DL- |
| | | AoD, Multi-RTT |
| Rel-16 DL PRS / | UE Rx-Tx time difference | Multi-RTT |
| Rel-16 SRS for | | |
| positioning | | |
| Rel. 15 SSB / CSI- | SS-RSRP(RSRP for RRM), SS- | E-CID |
| RS for RRM | RSRQ(for RRM), CSI-RSRP (for RRM), | |
| | CSI-RSRQ (for RRM), SS-RSRPB (for | |
| | RRM) | |

TABLE 5
gNB Measurements to enable RAT-dependent positioning techniques

| DL/UL Reference | | To facilitate support of the |
|---|---|---|
| Signals | gNB Measurements | following positioning techniques |
| Rel-16 SRS for | UL RTOA | UL-TDOA |
| positioning | | |
| Rel-16 SRS for | UL SRS-RSRP | UL-TDOA, UL-AoA, Multi- |
| positioning | | RTT |
| Rel-16 SRS for | gNB Rx-Tx time | Multi-RTT |
| positioning, Rel-16 DL PRS | difference | |
| Rel-16 SRS for | A-AoA and Z-AoA | UL-AoA, Multi-RTT |
| positioning, | | |

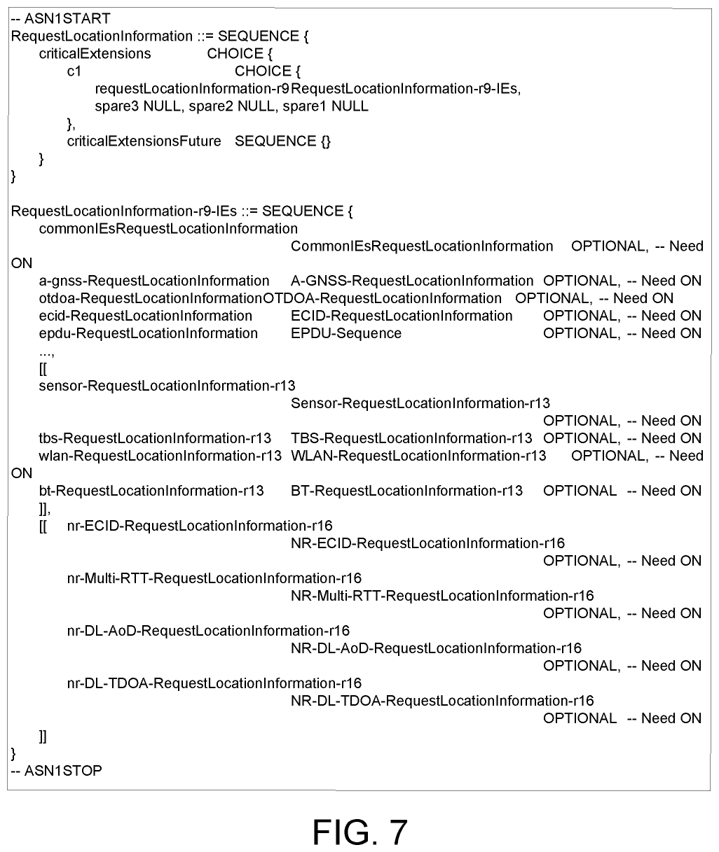

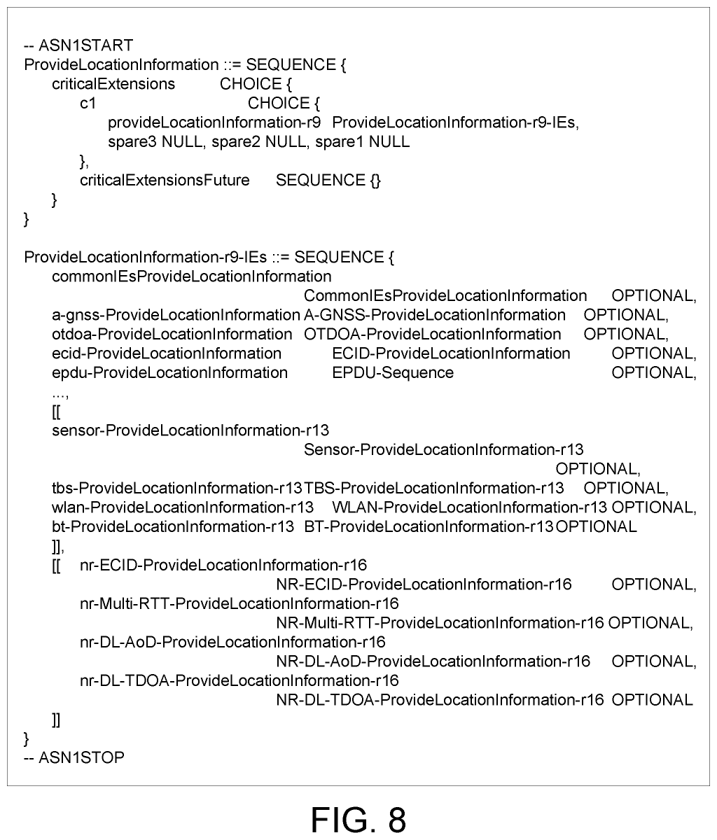

For a conceptual overview of the current Uu implementation in Rel-16, the overall measurement configuration and reporting is illustrated FIG. 7 and FIG. 8. In one embodiment, the measurement and reporting are performed per configured RAT-dependent/RAT-independent positioning method.

FIG. 7 illustrates an example of an LPP RequestLocationInformation message that supports techniques for SL power control for PRS transmission in accordance with aspects of the present disclosure. In particular, FIG. 7 depicts the RequestLocationInformation message body in a LPP message that is used by the location server to request positioning measurements or a position estimate from the target device.

FIG. 8 illustrates an example of an LPP ProvideLocationInformation message that supports techniques for SL power control for PRS transmission in accordance with aspects of the present disclosure. In particular, FIG. 8 depicts the ProvideLocationInformation message body in a LPP message is used by the target device to provide positioning measurements or position estimates to the location server.

Regarding RAT-dependent positioning measurements, the different DL measurements including DL PRS-RSRP, DL RSTD and UE Rx-Tx Time Difference required for the supported RAT-dependent positioning techniques are shown in Table 6. The following measurement configurations are specified, e.g., in TS 38.215 (incorporated herein by reference):

i. 4 Pair of DL RSTD measurements can be performed per pair of cells. Each measurement is performed between a different pair of DL PRS Resources/Resource Sets with a single reference timing.

ii. 8 DL PRS RSRP measurements can be performed on different DL PRS resources from the same cell.

TABLE 6
DL Measurements required for DL-based positioning methods
DL PRS reference signal received power (DL PRS-RSRP)

| | |
|---|---|
| Definition | DL PRS reference signal received power (DL PRS-RSRP), is defined as |
| | the linear average over the power contributions (in [W]) of the resource |
| | elements that carry DL PRS reference signals configured for RSRP |
| | measurements within the considered measurement frequency bandwidth. |
| | For frequency range 1, the reference point for the DL PRS-RSRP shall |
| | be the antenna connector of the UE. For frequency range 2, DL PRS-RSRP |
| | shall be measured based on the combined signal from antenna elements |
| | corresponding to a given receiver branch. For frequency range 1 and 2, if |
| | receiver diversity is in use by the UE, the reported DL PRS-RSRP value shall |
| | not be lower than the corresponding DL PRS-RSRP of any of the individual |
| | receiver branches. |
| Applicable | RRC_CONNECTED intra-frequency, |
| for | RRC_CONNECTED inter-frequency |

DL reference signal time difference (DL RSTD)

| | |
|---|---|
| Definition | DL reference signal time difference (DL RSTD) is the DL relative |
| | timing difference between the positioning node j and the reference positioning |
| | node i, defined as TS_{ubframeRxj} − T_{SubframeRxi}, |
| | Where: |
| | T_{SubframeRxj} is the time when the UE receives the start of one subframe |
| | from positioning node j. |
| | T_{SubframeRxi} is the time when the UE receives the corresponding start of |
| | one subframe from positioning node i that is closest in time to the subframe |
| | received from positioning node j. |
| | Multiple DL PRS resources can be used to determine the start of one |
| | subframe from a positioning node. |
| | For frequency range 1, the reference point for the DL RSTD shall be the |
| | antenna connector of the UE. For frequency range 2, the reference point for the |
| | DL RSTD shall be the antenna of the UE. |
| Applicable | RRC_CONNECTED intra-frequency |
| for | RRC_CONNECTED inter-frequency |

UE Rx − Tx time difference

| | |
|---|---|
| Definition | The UE Rx − Tx time difference is defined as TUE-RX - TUE-TX |
| | Where: |
| | T_{UE-RX} is the UE received timing of downlink subframe #i from a |
| | positioning node, defined by the first detected path in time. |
| | TUE-TX is the UE transmit timing of uplink subframe #j that is closest in |
| | time to the subframe #i received from the positioning node. |
| | Multiple DL PRS resources can be used to determine the start of one |
| | subframe of the first arrival path of the positioning node. |
| | For frequency range 1, the reference point for T_{UE-RX} measurement shall |
| | be the Rx antenna connector of the UE and the reference point for TUE-TX |
| | measurement shall be the Tx antenna connector of the UE. For frequency range |
| | 2, the reference point for T_{UE-RX} measurement shall be the Rx antenna of the UE |
| | and the reference point for T_{UE-TX} measurement shall be the Tx antenna of the |
| | UE. |
| Applicable | RRC_CONNECTED intra-frequency |
| for | RRC_CONNECTED inter-frequency |

In one embodiment, this disclosure details solutions for initiator, anchor, and responder devices to control the SL PRS power based on the type of configured SL positioning technique. An overview of the methods is presented as follows:

In one embodiment, a method is disclosed to configure and adapt the SL PRS transmission power for many one-to-one and one-to-many (groupcast) SL positioning methods. The adaptation of the SL PRS transmit power may entail the increase or reduction of the transmit to reduce interference while increasing hearability of the SL PRS at the responder device (at the receiver). The increase or reduction of the SL PRS transmit power may occur using stepwise granular control, e.g., a device may be configured to progressively increase the SL PRS transmit power in steps 0.5 dBm, corresponding to 1 dBm, 0.5 dBm, 2 dBm, . . . , etc. In one embodiment, a method is disclosed to configure the anchor devices with a muting configuration for SL PRS transmission depending on the relative distance between the anchor device and responder device. In one embodiment, a method is disclosed to configure and adapt the SL PRS transmission power using DL and SL pathloss references.

It is noted that, in one embodiment, an initiator device initiates a SL positioning/ranging session and a responder device responds to a SL positioning/ranging session from an initiator device. Further, Embodiments 1-3, described below, may be implemented in combination with each other to support NR RAT-independent positioning over the SL (PC5) interface. In one embodiment, for the purposes of this disclosure, a positioning-related reference signal may be referred to as a reference signal used for positioning procedures/purposes in order to estimate a target-UE's location, e.g., PRS, or based on existing reference signals such as channel state information (“CSI”) reference signal (“RS”) (“CSI-RS”) or sounding reference signal (“SRS”). In one embodiment, a target-UE may be referred to as the device/entity to be localized/positioned. In various embodiments, the term “PRS” may refer to any signal such as a reference signal, which may or may not be used primarily for positioning. In one embodiment, a target-UE may be referred to as a UE of interest whose position (e.g., absolute or relative) is to be obtained by the network or by the UE itself.

According to Embodiment 1, in one embodiment, the SL positioning methods can be optimized to enhance the SL PRS power control for coordinated many one-to-one transmissions, which is applicable when performing SL TDoA using at least three or more anchor nodes, especially when detectability of the SL PRS at the target UE from the desired anchor node is key to the measurement accuracy the SL reference signal time difference (“RSTD”) measurement.

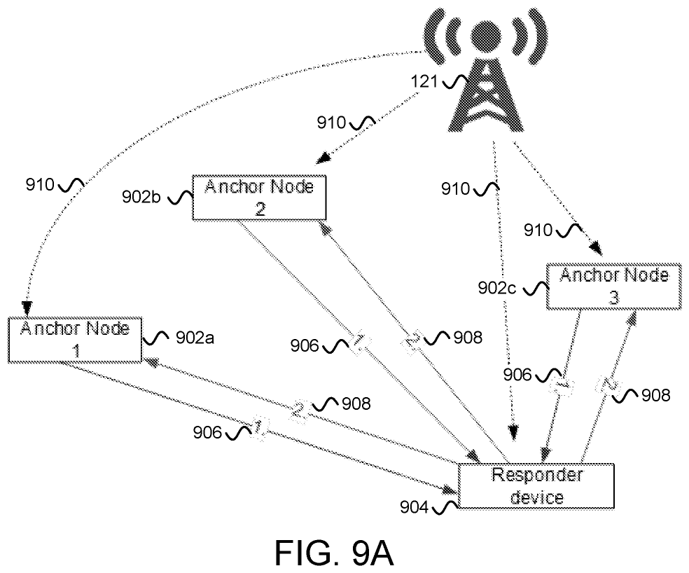

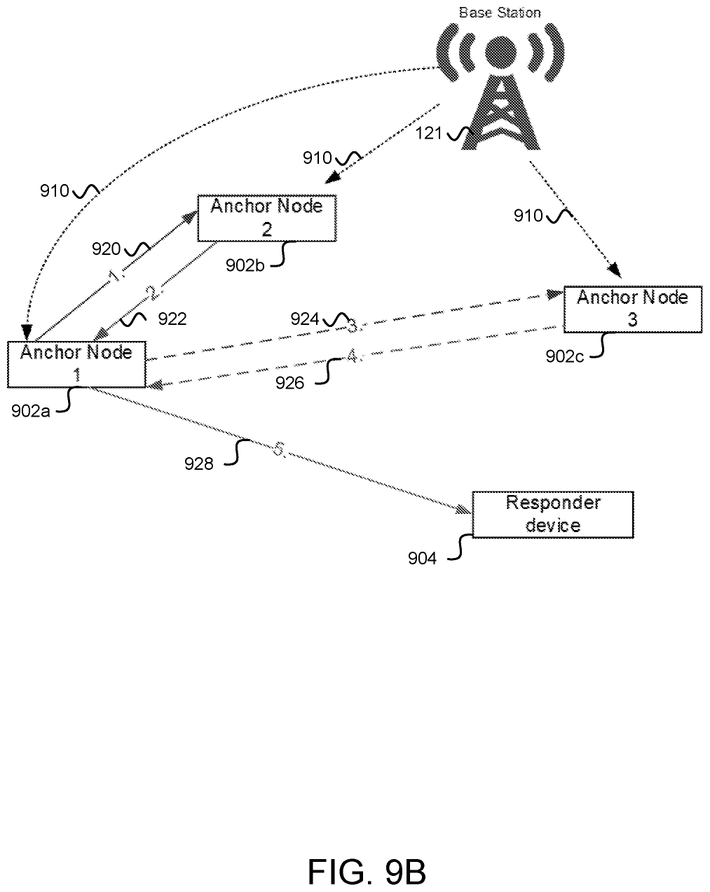

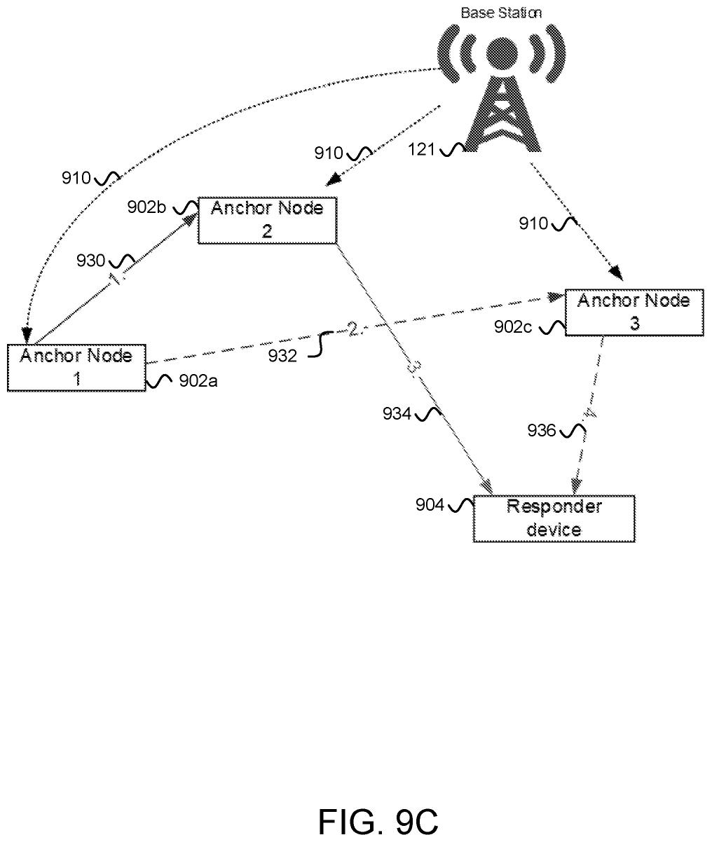

FIG. 9A illustrates an example of adaptive SL Tx power for SL PRS that supports techniques for SL power control for PRS transmission in accordance with aspects of the present disclosure. In particular, FIG. 9A depicts an embodiment of an adaptive SL Tx power for SL PRS from an anchor node. In an implementation option, the initiator device or anchor device 902a-c may control the transmission power of the SL PRS using the PSSCH based on the SL pathloss estimate computed by the anchor device 902a-c. The initiator device and/or anchor device 902a-c may rely on SL pathloss computed from the configured SL RS measurements. The feedback provided by the responder device (target device) 904 may be based on average received signal strength (“RSS”) metrics including RSRP, RSSI, or the like. The averaging may be performed within a configured window, configured time period, or the like. The responder device 904 may also feedback the computed SL pathloss to at least one or more anchor nodes 902a-c involved in a many one-to-one SL positioning session (e.g., SL-TDoA).

In another implementation, each of the anchor devices 902a-c may derive the inter-anchor-device SL pathloss to adapt the SL PRS transmit power control to the responder device with respect to other anchor devices 902a-c. In one embodiment, each of the anchor nodes 902a-c may derive the SL pathloss with respect to other anchor devices based on received anchor device RSS measurements. In one embodiment, this enables a more coordinated approach to transmit SL PRS in relation to other anchor devices 902a-c without causing significant interference, while also improving hearability of the respective SL PRS signals at the responder (receiver) side.

In another implementation option, the responder device 904 may control the transmission power of the (reply) SL PRS using the physical sidelink shared channel (“PSSCH”) based on only the SL pathloss estimate computed by the responder device 904. Furthermore, the responder device 904 may rely on the provided SL assistance information comprising at least the SL transmit power provided by the anchor device 904a-c, which may be signaled using sidelink control information (“SCI”), PSSCH, PC5 RRC, SL LTE positioning protocol (“LPP”), SL MAC CE, and/or the like signaling.

In one embodiment, communication links 906 in FIG. 9A may be used to illustrate transmission of SL PRS at certain fixed SL Tx power from the anchor nodes 902a-c and/or transmission of SL PRS and signal anchor node SL Tx power from the anchor nodes 902a-c. In one embodiment, communication links 908 in FIG. 9A may be used to illustrate responder device 904 reporting average SL PRS RSRP and/or responder device 904 transmitting SL PRS with adapted SL Tx power in response to calculating SL pathloss reference. In one embodiment, communication links 910 in FIG. 9A may be used to illustrate (optional) signaling of the DL pathloss reference.

For the above implementation options, SL positioning techniques employing one or more anchor nodes 902a-c may be applicable including: SL-TDoA, SL-RTT, two-way ranging, SL AoA/AoD, SL RRM-based methods.

In another implementation, the need for employing SL PRS power control and the adaptation of SL PRS transmit power may be computed as a function of the zone of each of the anchor devices 902a-c. The zone represents a course geographic indicator of the relative distance between the anchor device 902a-c and responder device 904. Based on a zone ID, in one embodiment, the anchor device 902a-c and/or responder device 904 may decide to employ the SL PRS power control procedures. The zone may comprise a rectangular or circular grid-like structure that is bounded by geographical latitude and longitudinal points. In exemplary implementations, if the anchor/initiator device 902a-c is within the same zone (e.g., sharing the same zone ID), then SL PRS transmit power may be adjusted accordingly by reducing the SL PRS transmit power when compared to the scenario where the anchor/initiator device 902a-c and responder device 904 have different zone IDs, wherein this scenario the SL PRS transmit power may have to be increased.

In an alternative implementation, the need for employing SL PRS power control and the adaptation of SL PRS transmit power may be dependent on the determination of the SL pathloss reference with respect to other anchor nodes 902a-c. In a SL positioning scenario requiring two or more anchor nodes 902a-c, having knowledge of the other anchor's node 902a-c SL PRS transmit power characteristics may help in adapting the SL PRS transmit power of the concerned anchor node 902a-c towards the responder device.

FIG. 9B illustrates an example of adaptive SL PRS Tx power that supports techniques for SL power control for PRS transmission in accordance with aspects of the present disclosure. In particular, FIG. 9B is a conceptual exemplary diagram of enabling one anchor node 902a-c to adapt its SL PRS transmit power with respect to other anchor node's 902a-c participating in the SL positioning session (e.g., performing SL-TDoA) as part of Scenario 1. At step 1 (see messaging 920), in one embodiment, anchor node 1 902a transmits SL RS to anchor node 2 902b at certain fixed SL Tx power. At step 2 (see messaging 922), in one embodiment, anchor node 2 902b reports average SL RS RSRP to anchor node 1 902a. At step 3 (see messaging 924), in one embodiment, anchor node 1 902a transmits SL RS to anchor node 3 902c at certain fixed SL Tx power. At step 4 (see messaging 926), in one embodiment, anchor node 3 902c reports average SL RS RSRP to anchor node 1 902a. At step 5 (see messaging 928), in one embodiment, anchor node 1 902a computes SL pathloss reference 2 and 3 with respect to anchor nodes 2 902b and 3 902c, respectively, and adapts SL PRS Tx power to the responder device 904.

FIG. 9C illustrates another example of adaptive SL PRS Tx power that supports techniques for SL power control for PRS transmission in accordance with aspects of the present disclosure. In particular, FIG. 9C shows another scenario (Scenario 2) wherein other anchor nodes 902a-c may adapt their SL PRS transmit power based on the information provided by anchor node 1 902a. At step 1 (see messaging 930), in one embodiment, anchor node 1 902a transmits SL RS to anchor node 2 902b, anchor node 1 SL Tx power to responder device 904, and anchor node 1 SL Tx power to anchor node 2 902b. At step 2 (see messaging 932), in one embodiment, anchor node 1 902a transmits SL RS to anchor node 3 902c, anchor node 1 SL Tx power to responder device 904, and anchor node 1 SL Tx power to anchor node 3 902c. At step 3 (see messaging 934), in one embodiment, anchor node 2 902b computes SL pathloss reference with respect to anchor node 1 902a and adapts SL PRS Tx power to responder device 904. At step 4 (see messaging 936), in one embodiment, anchor node 3 902c computes SL pathloss reference with respect to anchor node 1 902a and adapts SL PRS Tx power to responder device 904.

In one embodiment, according to FIG. 9C, anchor node 1 902a may share the following information (as a part of the assistance information) with Anchor nodes 2 902b and 3 902c using PC5 RRC, PC5-S, SL positioning protocol, SL MAC CE, and/or the like. The following may be signaled: SL RS/PRS transmit power to Anchor nodes 2 902b and 3 902c; SL RS/PRS transmit power to the responder device 904; Absolute/relative location information to Anchor device 2 902b and 3 902c including 2D/3D latitude and longitude information, velocity estimates including e.g., indication of mobility, e.g., high, medium or low, and height/altitude information; type of anchor device 902a-c, e.g., roadside unit, UE, and/or the like; antenna and panel related information including antenna panel locations, orientations, or the like; in the case of SL-TDOA, the anchor node 902a-c may additionally share an indication on whether it is a reference anchor node 902a-c; and device/UE power class information indicating the anchor nodes' 902a-c transmit power capabilities, which may also be signaled using solicited or unsolicited capability exchange messages (e.g., using PC5 RRC).

In one embodiment, the above information to be shared among devices including anchor/initiator 902a-c and responder devices 904 may also be applicable to the procedures described in FIGS. 9a-9c. Furthermore, examples of other SL reference signals (apart from SL positioning reference signals) may include, but is not limited to: SL CSI-RS, SL PT-RS, PSCCH DMRS, PSCCH DMRS, S-SSB, or the like. Additionally, in one embodiment, the sharing/reporting of the above information may be event triggered based on a network/UE-configured threshold (e.g., RSRP or other RSS metrics such as RSSI, or the like). In an alternative implementation, the sharing/reporting of the above information may be periodical with a configured periodicity, activation/deactivation, and slot offset.

According to Embodiment 2, in one embodiment, the network may (pre)configure a specific muting configuration to minimize interference from anchor nodes closer to the responder device in relation to other anchor devices. The muting configuration may allow the SL PRS signal to be transmitted with zero/minimal power such that the SL PRS may not interfere with the SL PRS of nearby anchor nodes. In one embodiment, the anchor node muting configuration for SL PRS resources may be configured on one or more of the following SL PRS resource granularities including SL positioning frequency, SL positioning/data resource pool, resource sets, resources, and/or the like.

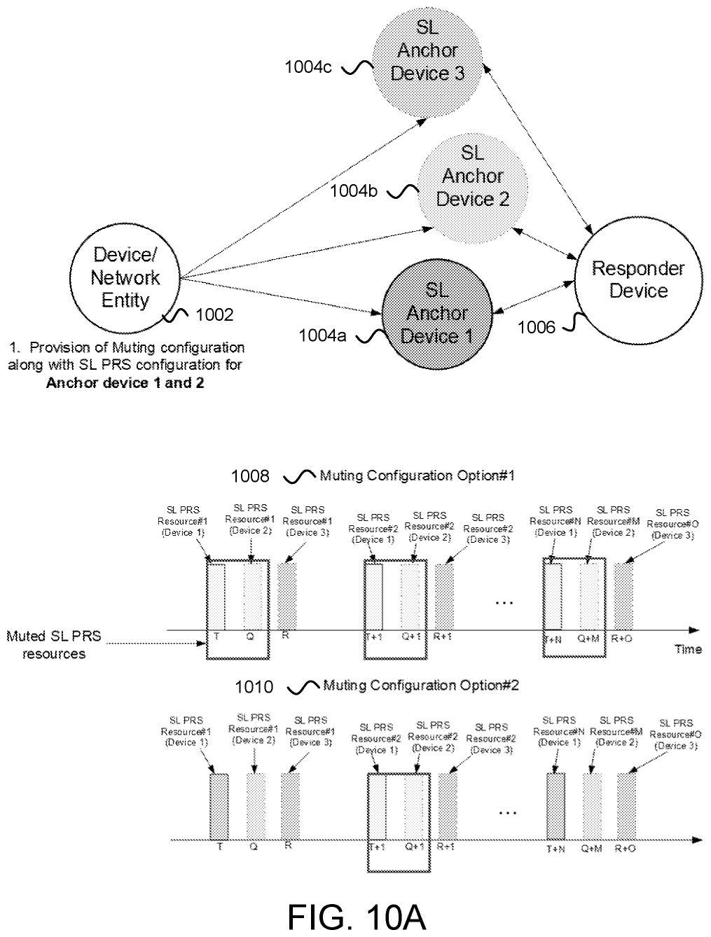

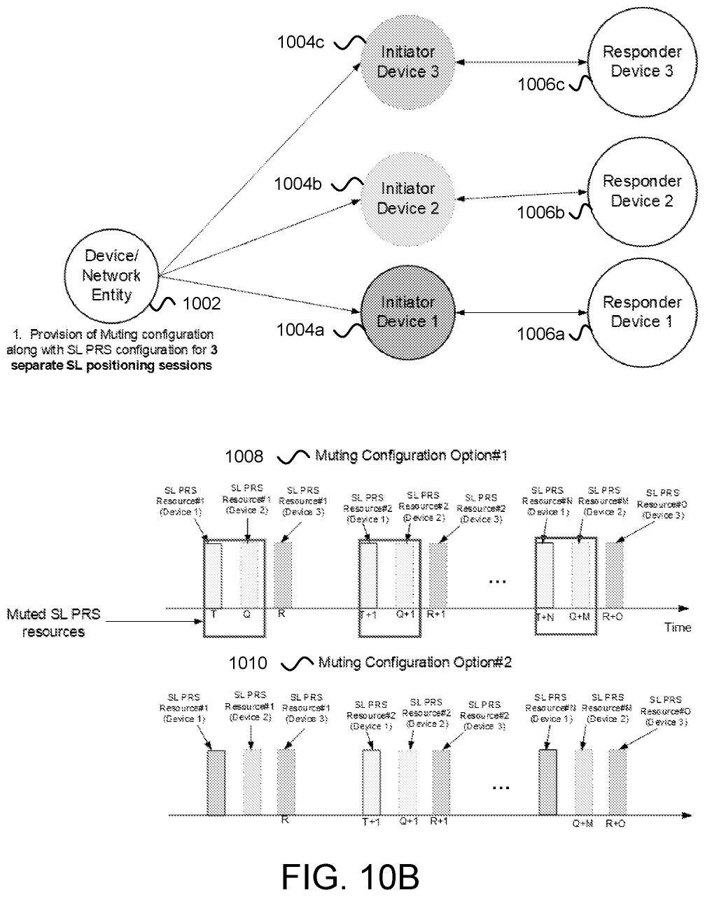

FIG. 10A illustrates an example of muting configurations for groupcast SL positioning that supports techniques for SL power control for PRS transmission in accordance with aspects of the present disclosure. According to FIG. 10A, a configuration entity 1002 may provide a muting configuration to anchor devices 1 1004a and 2 1004b since their SL PRS transmissions may lower the hearability of SL PRS transmitted from anchor device 3 1004c, which is further away from the responder device 1006. The muting configuration may apply to all configured (periodical) SL PRS resources from anchor devices 1 1004a and 2 1004b (shown by muting configuration option #1 1008) or may apply to a subset of SL PRS resources within a totality of configured resources (shown by muting configuration option #2 1010).

The muting configuration may be signaled as a bitmap, a bitstring of SL PRS resources to be muted, and may be conveyed to the anchor devices using DCI, RRC, DL MAC CE, LPP, SCI, PSSCH, PC5 RRC, SL MAC CE, and/or the like signaling. In another implementation, initiator devices may be individually provided with a muting configuration by a configuration entity, which may be comprise a network entity or UE/device.

In another implementation, the muting configuration options may be applicable to two or more separate ranging sessions. FIG. 10B illustrates another example of muting configurations for separate unicast SL positioning/ranging sessions that support techniques for SL power control for PRS transmission in accordance with aspects of the present disclosure. In particular, FIG. 10B depicts one illustration where the separate muting configurations can be applied to separate SL positioning/ranging sessions.

According to Embodiment 3, an open loop power control mechanism is applied to SL PRS transmissions transmitted within the PSSCH region of a slot. In this scenario, in one embodiment, there are two applicable methods to consider when the SL PRS is transmitted with or without PSCCH symbols. To improve hearability and detection of the SL PRS, in one embodiment, it is recommended that the SL PRS not be multiplexed with SL data symbols, but due to efficiency of the allocating time-frequency resources for SL PRS and data transmissions, this may inevitably be another transmission option.

Depending on the coverage scenario of the initiator device, in one embodiment, the SL PRS may be transmitted based on power control procedures, which may exploit different pathloss reference parameters. This may vary depending on the proximity of the initiator UE or anchor nodes with respect to the serving base station (e.g., gNB) and other anchor nodes or target devices.

In one implementation option, the initiator device or anchor device may control the transmission power of the SL PRS using the PSSCH based on only the DL pathloss estimate computed by the initiator device or anchor device. This DL pathloss may already be derived based on previously received RS signals such as SSB, CSI-RS, or the like. In an alternative option, the initiator UE/anchor device may be (pre)configured with a DL pathloss reference by the serving gNB. This method may be applied to one-on-one (unicast) SL positioning techniques such as RTT, two-way ranging, SL AoA, and/or the like. In the case that DL pathloss is required, the transmit power for SL PRS may be calculated using the following model:

$${P}_{SL - PRS} = min \{ {P}_{cmax} , {P}_{0 , DL} + 10 {log}_{10} ( {2}^{μ} {M}_{PSSCH} ) + {α}_{DL} {PL}_{DL} \} \qquad ( 1 )$$

where P_{cmax} is the UE configured maximum transmit power, P_{0,DL} is the nominal power provide to the initiator/anchor device, μ refers to the sub-carrier spacing at which the SL PRS is transmitted, M_{PSSCH}=L_{sub}M_{sub} refers to the number of physical resource blocks (PRBs) required to transmit the SL PRS as function of the number of sub-channels (L_{sub}) and number PRBs per sub-channel (M_{sub}), α_{DL} is the configured fractional power factor together with the computed DL pathloss (PL_{DL}). In one embodiment, the initiator/anchor device selects the minimum transmit power value from the argument.

In another implementation option, the initiator device or anchor device may control the transmission power of the SL PRS using the PSSCH based on only the SL pathloss estimate computed by the initiator device or anchor device. The initiator device and/or anchor device may rely on a priori feedback from the responder device, e.g., based on previous PSSCH transmissions, SL RS signals, or the like, to compute the SL pathloss. The feedback provided by the responder device may be based on average received signal strength metrics (“RSS”) metrics including RSRP, RSSI, or the like. The averaging may be performed within a configured window, time period, or the like. The feedback for computing the SL pathloss may also contain a report of average SL PRS RSRP over a given time interval. The initiator device may compute the SL pathloss. In the case that SL pathloss is required, the transmit power for SL PRS may be calculated using the following model:

$${P}_{SL - PRS} = min \{ {P}_{cmax} , {P}_{0 , SL} + 10 {log}_{10} ( {2}^{μ} {M}_{PSSCH} ) + {α}_{SL} {PL}_{SL} \} \qquad ( 2 )$$

where P_{cmax} is the UE configured maximum transmit power, P_{0,SL} is the nominal power provide to the initiator/anchor device, μ refers to the sub-carrier spacing at which the SL PRS is transmitted, M_{PSSCH}=L_{sub}M_{sub} refers to the number of physical resource blocks (PRBs) required to transmit the SL PRS as function of the number of sub-channels (L_{sub}) and number PRBs per sub-channel (M_{sub}), α_{SL} is the configured fractional power factor together with the computed SL pathloss (PL_{SL}). Similar to the above, in one embodiment, the initiator/anchor device selects the minimum transmit power value from the argument.

In another further implementation option, the initiator UE may also signal the SL PRS transmit power to the responder device, to enable the responder device to determine the power at which to transmit the SL PRS reply signal.

Eq. (1) may be beneficial for controlling the SL PRS power in-coverage scenarios, while Eq. (2) may be beneficial for partial coverage and out-of-coverage scenarios. In a further implementation, Eqs. (1) and (2) may be combined to also determine the SL PRS transmit power, which exploits both the DL and SL pathloss values.

The parameters of Eq. 1 and 2 may also be signaled to the initiator device/anchor device/responder device using dedicated or broadcast signaling (positioning system information blocks (posSIBs), normal SIBs). Examples of dedicated signaling may include DCI, RRC, DL MAC CE, LPP, SCI, PSSCH, PC5 RRC, SL MAC CE, and/or the like.

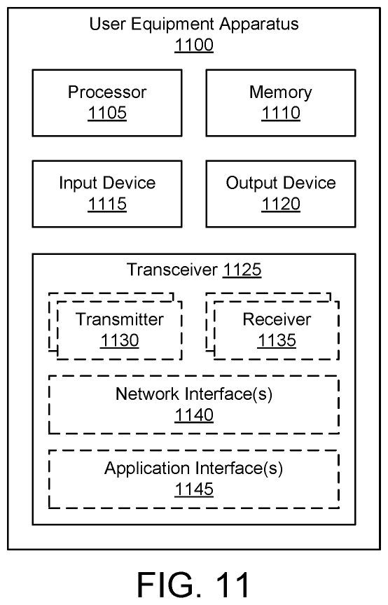

FIG. 11 depicts a UE apparatus 1100 that may be used for techniques for SL power control for PRS transmission, according to embodiments of the disclosure. In various embodiments, the UE apparatus 1100 is used to implement one or more of the solutions described above. The UE apparatus 1100 may be one embodiment of the remote unit 105 and/or the UE 205, described above. Furthermore, the UE apparatus 1100 may include a processor 1105, a memory 1110, an input device 1115, an output device 1120, and a transceiver 1125.

In some embodiments, the input device 1115 and the output device 1120 are combined into a single device, such as a touchscreen. In certain embodiments, the UE apparatus 1100 may not include any input device 1115 and/or output device 1120. In various embodiments, the UE apparatus 1100 may include one or more of: the processor 1105, the memory 1110, and the transceiver 1125, and may not include the input device 1115 and/or the output device 1120.

As depicted, the transceiver 1125 includes at least one transmitter 1130 and at least one receiver 1135. In some embodiments, the transceiver 1125 communicates with one or more cells (or wireless coverage areas) supported by one or more base units 121. In various embodiments, the transceiver 1125 is operable on unlicensed spectrum. Moreover, the transceiver 1125 may include multiple UE panels supporting one or more beams. Additionally, the transceiver 1125 may support at least one network interface 1140 and/or application interface 1145. The application interface(s) 1145 may support one or more APIs. The network interface(s) 1140 may support 3GPP reference points, such as Uu, N1, PC5, etc. Other network interfaces 1140 may be supported, as understood by one of ordinary skill in the art.

The processor 1105, in one embodiment, may include any known controller capable of executing computer-readable instructions and/or capable of performing logical operations. For example, the processor 1105 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 1105 executes instructions stored in the memory 1110 to perform the methods and routines described herein. The processor 1105 is communicatively coupled to the memory 1110, the input device 1115, the output device 1120, and the transceiver 1125.

In various embodiments, the processor 1105 controls the UE apparatus 1100 to implement the above-described UE behaviors. In certain embodiments, the processor 1105 may include an application processor (also known as “main processor”) which manages application-domain and operating system (“OS”) functions and a baseband processor (also known as “baseband radio processor”) which manages radio functions.

The memory 1110, in one embodiment, is a computer readable storage medium. In some embodiments, the memory 1110 includes volatile computer storage media. For example, the memory 1110 may include a RAM, including dynamic RAM (“DRAM”), synchronous dynamic RAM (“SDRAM”), and/or static RAM (“SRAM”). In some embodiments, the memory 1110 includes non-volatile computer storage media. For example, the memory 1110 may include a hard disk drive, a flash memory, or any other suitable non-volatile computer storage device. In some embodiments, the memory 1110 includes both volatile and non-volatile computer storage media.

In some embodiments, the memory 1110 stores data related to techniques for SL power control for PRS transmission. For example, the memory 1110 may store various parameters, panel/beam configurations, resource assignments, policies, and the like as described above. In certain embodiments, the memory 1110 also stores program code and related data, such as an operating system or other controller algorithms operating on the apparatus 1100.

The input device 1115, in one embodiment, may include any known computer input device including a touch panel, a button, a keyboard, a stylus, a microphone, or the like. In some embodiments, the input device 1115 may be integrated with the output device 1120, for example, as a touchscreen or similar touch-sensitive display. In some embodiments, the input device 1115 includes a touchscreen such that text may be input using a virtual keyboard displayed on the touchscreen and/or by handwriting on the touchscreen. In some embodiments, the input device 1115 includes two or more different devices, such as a keyboard and a touch panel.

The output device 1120, in one embodiment, is designed to output visual, audible, and/or haptic signals. In some embodiments, the output device 1120 includes an electronically controllable display or display device capable of outputting visual data to a user. For example, the output device 1120 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 1120 may include a wearable display separate from, but communicatively coupled to, the rest of the UE apparatus 1100, such as a smart watch, smart glasses, a heads-up display, or the like. Further, the output device 1120 may be a component of a smart phone, a personal digital assistant, a television, a table computer, a notebook (laptop) computer, a personal computer, a vehicle dashboard, or the like.

In certain embodiments, the output device 1120 includes one or more speakers for producing sound. For example, the output device 1120 may produce an audible alert or notification (e.g., a beep or chime). In some embodiments, the output device 1120 includes one or more haptic devices for producing vibrations, motion, or other haptic feedback. In some embodiments, all, or portions of the output device 1120 may be integrated with the input device 1115. For example, the input device 1115 and output device 1120 may form a touchscreen or similar touch-sensitive display. In other embodiments, the output device 1120 may be located near the input device 1115.

The transceiver 1125 communicates with one or more network functions of a mobile communication network via one or more access networks. The transceiver 1125 operates under the control of the processor 1105 to transmit messages, data, and other signals and to receive messages, data, and other signals. For example, the processor 1105 may selectively activate the transceiver 1125 (or portions thereof) at times to send and receive messages.

The transceiver 1125 includes at least transmitter 1130 and at least one receiver 1135. One or more transmitters 1130 may be used to provide UL communication signals to abase unit 121, such as the UL transmissions described herein. Similarly, one or more receivers 1135 may be used to receive DL communication signals from the base unit 121, as described herein. Although only one transmitter 1130 and one receiver 1135 are illustrated, the UE apparatus 1100 may have any suitable number of transmitters 1130 and receivers 1135. Further, the transmitter(s) 1130 and the receiver(s) 1135 may be any suitable type of transmitters and receivers. In one embodiment, the transceiver 1125 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 1125, transmitters 1130, and receivers 1135 may be implemented as physically separate components that access a shared hardware resource and/or software resource, such as for example, the network interface 1140.

In various embodiments, one or more transmitters 1130 and/or one or more receivers 1135 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 1130 and/or one or more receivers 1135 may be implemented and/or integrated into a multi-chip module. In some embodiments, other components such as the network interface 1140 or other hardware components/circuits may be integrated with any number of transmitters 1130 and/or receivers 1135 into a single chip. In such embodiment, the transmitters 1130 and receivers 1135 may be logically configured as a transceiver 1125 that uses one more common control signals or as modular transmitters 1130 and receivers 1135 implemented in the same hardware chip or in a multi-chip module.

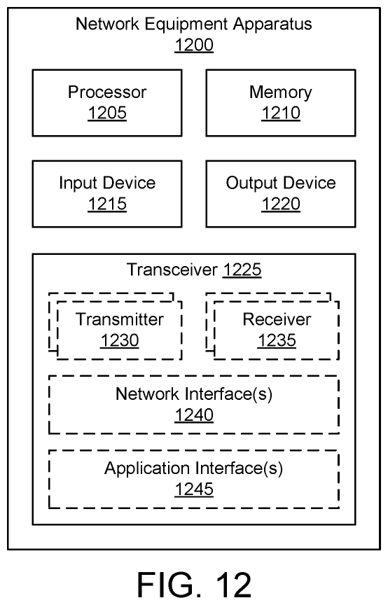

FIG. 12 depicts a NE apparatus 1200 that may be used for techniques for SL power control for PRS transmission, according to embodiments of the disclosure. In one embodiment, NE apparatus 1200 may be one implementation of a RAN node, such as the base unit 121 and/or the RAN node 210, as described above. Furthermore, the base NE apparatus 1200 may include a processor 1205, a memory 1210, an input device 1215, an output device 1220, and a transceiver 1225.

In some embodiments, the input device 1215 and the output device 1220 are combined into a single device, such as a touchscreen. In certain embodiments, the NE apparatus 1200 may not include any input device 1215 and/or output device 1220. In various embodiments, the NE apparatus 1200 may include one or more of: the processor 1205, the memory 1210, and the transceiver 1225, and may not include the input device 1215 and/or the output device 1220.

As depicted, the transceiver 1225 includes at least one transmitter 1230 and at least one receiver 1235. Here, the transceiver 1225 communicates with one or more remote units 175. Additionally, the transceiver 1225 may support at least one network interface 1240 and/or application interface 1245. The application interface(s) 1245 may support one or more APIs. The network interface(s) 1240 may support 3GPP reference points, such as Uu, N1, N2 and N3. Other network interfaces 1240 may be supported, as understood by one of ordinary skill in the art.

The processor 1205, in one embodiment, may include any known controller capable of executing computer-readable instructions and/or capable of performing logical operations. For example, the processor 1205 may be a microcontroller, a microprocessor, a CPU, a GPU, an auxiliary processing unit, a FPGA, or similar programmable controller. In some embodiments, the processor 1205 executes instructions stored in the memory 1210 to perform the methods and routines described herein. The processor 1205 is communicatively coupled to the memory 1210, the input device 1215, the output device 1220, and the transceiver 1225.

In various embodiments, the NE apparatus 1200 is a RAN node (e.g., gNB) that communicates with one or more UEs, as described herein. In such embodiments, the processor 1205 controls the NE apparatus 1200 to perform the above-described RAN behaviors. When operating as a RAN node, the processor 1205 may include an application processor (also known as “main processor”) which manages application-domain and OS functions and a baseband processor (also known as “baseband radio processor”) which manages radio functions.

The memory 1210, in one embodiment, is a computer readable storage medium. In some embodiments, the memory 1210 includes volatile computer storage media. For example, the memory 1210 may include a RAM, including DRAM, SDRAM, and/or SRAM. In some embodiments, the memory 1210 includes non-volatile computer storage media. For example, the memory 1210 may include a hard disk drive, a flash memory, or any other suitable non-volatile computer storage device. In some embodiments, the memory 1210 includes both volatile and non-volatile computer storage media.

In some embodiments, the memory 1210 stores data related to techniques for SL power control for PRS transmission. For example, the memory 1210 may store parameters, configurations, resource assignments, policies, and the like, as described above. In certain embodiments, the memory 1210 also stores program code and related data, such as an operating system or other controller algorithms operating on the apparatus 1200.

The input device 1215, in one embodiment, may include any known computer input device including a touch panel, a button, a keyboard, a stylus, a microphone, or the like. In some embodiments, the input device 1215 may be integrated with the output device 1220, for example, as a touchscreen or similar touch-sensitive display. In some embodiments, the input device 1215 includes a touchscreen such that text may be input using a virtual keyboard displayed on the touchscreen and/or by handwriting on the touchscreen. In some embodiments, the input device 1215 includes two or more different devices, such as a keyboard and a touch panel.

The output device 1220, in one embodiment, is designed to output visual, audible, and/or haptic signals. In some embodiments, the output device 1220 includes an electronically controllable display or display device capable of outputting visual data to a user. For example, the output device 1220 may include, but is not limited to, an LCD display, an LED display, an OLED display, a projector, or similar display device capable of outputting images, text, or the like to a user. As another, non-limiting, example, the output device 1220 may include a wearable display separate from, but communicatively coupled to, the rest of the NE apparatus 1200, such as a smart watch, smart glasses, a heads-up display, or the like. Further, the output device 1220 may be a component of a smart phone, a personal digital assistant, a television, a table computer, a notebook (laptop) computer, a personal computer, a vehicle dashboard, or the like.

In certain embodiments, the output device 1220 includes one or more speakers for producing sound. For example, the output device 1220 may produce an audible alert or notification (e.g., a beep or chime). In some embodiments, the output device 1220 includes one or more haptic devices for producing vibrations, motion, or other haptic feedback. In some embodiments, all, or portions of the output device 1220 may be integrated with the input device 1215. For example, the input device 1215 and output device 1220 may form a touchscreen or similar touch-sensitive display. In other embodiments, the output device 1220 may be located near the input device 1215.

The transceiver 1225 includes at least transmitter 1230 and at least one receiver 1235. One or more transmitters 1230 may be used to communicate with the UE, as described herein. Similarly, one or more receivers 1235 may be used to communicate with network functions in the PLMN and/or RAN, as described herein. Although only one transmitter 1230 and one receiver 1235 are illustrated, the NE apparatus 1200 may have any suitable number of transmitters 1230 and receivers 1235. Further, the transmitter(s) 1230 and the receiver(s) 1235 may be any suitable type of transmitters and receivers.

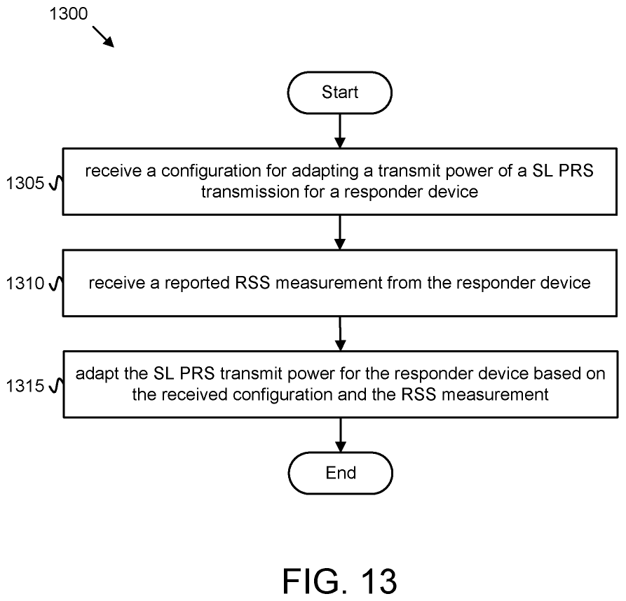

FIG. 13 depicts one embodiment of a method 1300 for techniques for SL power control for PRS transmission, according to embodiments of the disclosure. In various embodiments, the method 1300 is performed by a UE device in a mobile communication network, such as the remote unit 105, the UE 205, and/or the UE apparatus 1100, described above, and/or a NE apparatus 1200, such as base unit 121. In some embodiments, the method 1300 is performed by a processor, such as a microcontroller, a microprocessor, a CPU, a GPU, an auxiliary processing unit, a FPGA, or the like.

In one embodiment, the method 1300 receives 1305 a configuration for adapting a transmit power of a SL PRS transmission for a responder device. In one embodiment, the method 1300 receives 1310 a reported RSS measurement from the responder device. In one embodiment, the method 1300 adapts 1315 the SL PRS transmit power for the responder device based on the received configuration and the RSS measurement, and the method 1300 ends.

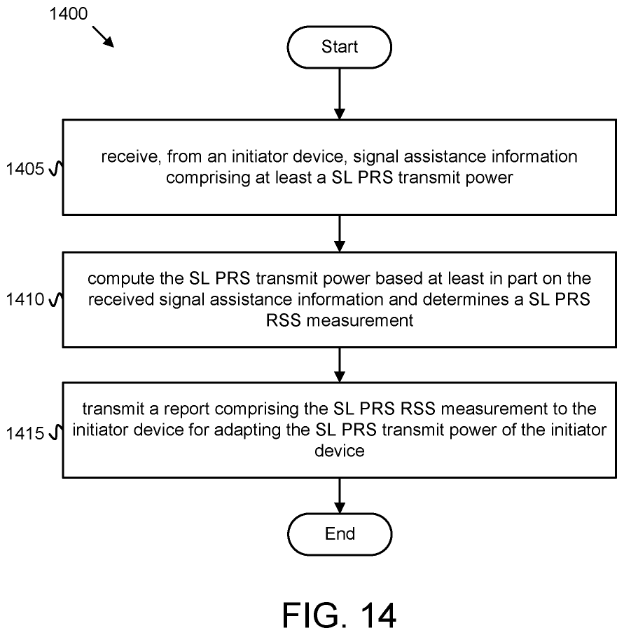

FIG. 14 depicts one embodiment of a method 1400 for techniques for SL power control for PRS transmission, according to embodiments of the disclosure. In various embodiments, the method 1400 is performed by a UE device in a mobile communication network, such as the remote unit 105, the UE 205, and/or the UE apparatus 1100, described above, and/or a NE apparatus 1200, such as base unit 121. In some embodiments, the method 1700 is performed by a processor, such as a microcontroller, a microprocessor, a CPU, a GPU, an auxiliary processing unit, a FPGA, or the like.

In one embodiment, the method 1400 receives 1405, from an initiator device, signal assistance information comprising at least a SL PRS transmit power. In one embodiment, the method 1400 computes 1410 the SL PRS transmit power based at least in part on the received signal assistance information and determines a SL PRS RSS measurement. In one embodiment, the method 1400 transmit 1415 a report comprising the SL PRS RSS measurement to the initiator device for adapting the SL PRS transmit power of the initiator device, and the method 1400 ends.

Disclosed herein is a first apparatus for techniques for SL power control for PRS transmission, according to embodiments of the disclosure. The first apparatus may be implemented by a UE device in a mobile communication network, such as the remote unit 105, the UE 205, and/or the UE apparatus 1100, described above, and/or a NE apparatus 1200, such as base unit 121. In one embodiment, the first apparatus is implemented by a processor, such as a microcontroller, a microprocessor, a CPU, a GPU, an auxiliary processing unit, a FPGA, or the like.

In one embodiment, the first apparatus includes a processor and a memory coupled to the processor. In one embodiment, the memory includes instructions that are executable by the processor to cause the apparatus to receive a configuration for adapting a transmit power of a SL PRS transmission for a responder device, receive a reported RSS measurement from the responder device, and adapt the SL PRS transmit power for the responder device based on the received configuration and the RSS measurement.

In one embodiment, the configuration is received from a configuration entity and the configuration comprises at least one of SL PRS transmit power control parameters and a muting configuration.

In one embodiment, the SL PRS transmit power control parameters comprise one or more of a UE configured transmit power, a nominal power, a fractional power loss, an SL pathloss, and a DL pathloss.

In one embodiment, the muting configuration is provided based on a relative distance between an anchor device and the responder device.

In one embodiment, the muting configuration applies to each configured SL PRS resource.

In one embodiment, the muting configuration applies to a subset of SL PRS resources within a totality of configured resources.

In one embodiment, the instructions are further executable by the processor to cause the apparatus to transmit signal assistance information to the responder device, the signal assistance information comprising at least the SL PRS transmit power.

In one embodiment, the instructions are further executable by the processor to cause the apparatus to receive a report from the responder device comprising a measurement of a SL PRS RSS metric for adapting the SL PRS transmit power, the SL PRS RSS metric comprising one or more of an RSRP and an RSSI.

In one embodiment, the instructions are further executable by the processor to cause the apparatus to receive, from the responder device, separate RSS measurement reports for adapting the SL PRS transmit power.

In one embodiment, the SL PRS transmit power is adapted from an anchor device and from the responder device within the same SL positioning session.

In one embodiment, the instructions are further executable by the processor to cause the apparatus to determine one or more SL pathloss values with respect to one or more of other anchor nodes and other initiating devices to adapt its SL PRS transmit power.

In one embodiment, the instructions are further executable by the processor to cause the apparatus to adapt the SL PRS transmit power based on the determined zone ID of the initiator device and the responder device.

In one embodiment, the apparatus comprises one or more of a base station, a roadside-unit, an anchor UE, and a location server, and a responding device may further comprise one or more of a roadside-unit, an anchor node, and other UEs participating in a positioning session.

Disclosed herein is a first method for techniques for SL power control for PRS transmission, according to embodiments of the disclosure. The first method is performed by a UE device in a mobile communication network, such as the remote unit 105, the UE 205, and/or the UE apparatus 1100, described above, and/or a NE apparatus 1200, such as base unit 121. In some embodiments, the first method is performed by a processor, such as a microcontroller, a microprocessor, a CPU, a GPU, an auxiliary processing unit, a FPGA, or the like.

In one embodiment, the first method receives a configuration for adapting a transmit power of a SL PRS transmission for a responder device, receives a reported RSS measurement from the responder device, and adapts the SL PRS transmit power for the responder device based on the received configuration and the RSS measurement.

In one embodiment, the configuration is received from a configuration entity and the configuration comprises at least one of SL PRS transmit power control parameters and a muting configuration.

In one embodiment, the SL PRS transmit power control parameters comprise one or more of a UE configured transmit power, a nominal power, a fractional power loss, an SL pathloss, and a DL pathloss.

In one embodiment, the muting configuration is provided based on a relative distance between an anchor device and the responder device.

In one embodiment, the muting configuration applies to each configured SL PRS resource.

In one embodiment, the muting configuration applies to a subset of SL PRS resources within a totality of configured resources.

In one embodiment, the method further includes transmitting signal assistance information to the responder device, the signal assistance information comprising at least the SL PRS transmit power.

In one embodiment, the method further includes receiving a report from the responder device comprising a measurement of a SL PRS RSS metric for adapting the SL PRS transmit power, the SL PRS RSS metric comprising one or more of an RSRP and an RSSI.

In one embodiment, the method further includes receiving, from the responder device, separate RSS measurement reports for adapting the SL PRS transmit power.

In one embodiment, the SL PRS transmit power is adapted from an anchor device and from the responder device within the same SL positioning session.

In one embodiment, the method further includes determining one or more SL pathloss values with respect to one or more of other anchor nodes and other initiating devices to adapt its SL PRS transmit power.

In one embodiment, the method further includes adapting the SL PRS transmit power based on the determined zone ID of the initiator device and the responder device.

In one embodiment, the apparatus comprises one or more of a base station, a roadside-unit, an anchor UE, and a location server, and a responding device may further comprise one or more of a roadside-unit, an anchor node, and other UEs participating in a positioning session.

Disclosed herein is a second apparatus for techniques for SL power control for PRS transmission, according to embodiments of the disclosure. The second apparatus may be implemented by a UE device in a mobile communication network, such as the remote unit 105, the UE 205, and/or the UE apparatus 1100, described above, and/or a NE apparatus 1200, such as base unit 121. In one embodiment, the second apparatus is implemented by a processor, such as a microcontroller, a microprocessor, a CPU, a GPU, an auxiliary processing unit, a FPGA, or the like.

In one embodiment, the second apparatus includes a processor and a memory coupled to the processor. In one embodiment, the memory includes instructions that are executable by the processor to cause the apparatus to receive, from an initiator device, signal assistance information comprising at least a SL PRS transmit power, compute the SL PRS transmit power based at least in part on the received signal assistance information and determines a SL PRS RSS measurement, and transmit a report comprising the SL PRS RSS measurement to the initiator device for adapting the SL PRS transmit power of the initiator device.

In one embodiment, the transceiver receives assistance information comprising one or more of the SL PRS transmit power, absolute or relative location information, type of device, reference anchor node indication, antenna related information, and power device class information.

Disclosed herein is a second method for techniques for SL power control for PRS transmission, according to embodiments of the disclosure. The second method is performed by a UE device in a mobile communication network, such as the remote unit 105, the UE 205, and/or the UE apparatus 1100, described above, and/or a NE apparatus 1200, such as base unit 121. In some embodiments, the second method is performed by a processor, such as a microcontroller, a microprocessor, a CPU, a GPU, an auxiliary processing unit, a FPGA, or the like.

In one embodiment, the second method receives, from an initiator device, signal assistance information comprising at least a SL PRS transmit power. In one embodiment, the second method computes the SL PRS transmit power based at least in part on the received signal assistance information and determines a SL PRS RSS measurement. In one embodiment, the second method transmits a report comprising the SL PRS RSS measurement to the initiator device for adapting the SL PRS transmit power of the initiator device.

In one embodiment, the second method receives assistance information comprising one or more of the SL PRS transmit power, absolute or relative location information, type of device, reference anchor node indication, antenna related information, and power device class information.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

1. An apparatus for wireless communication, comprising:
at least one memory; and
at least one processor coupled with the at least one memory and configured to cause the apparatus to:
receive a configuration for adapting a transmit power of a sidelink (“SL”) positioning reference signal (“PRS”) transmission for a responder device;
receive a reported received signal strength (“RSS”) measurement from the responder device; and
adapt the SL PRS transmit power for the responder device based on the received configuration and the RSS measurement.

2. The apparatus of claim 1, wherein the configuration is received from a configuration entity and the configuration comprises at least one of SL PRS transmit power control parameters and a muting configuration.

3. The apparatus of claim 2, wherein the SL PRS transmit power control parameters comprise one or more of a user equipment (“UE”) configured transmit power, a nominal power, a fractional power loss, an SL pathloss, and a downlink (“DL”) pathloss.

4. The apparatus of claim 2, wherein the muting configuration is provided based on a relative distance between an anchor device and the responder device.

5. The apparatus of claim 2, wherein the muting configuration applies to each configured SL PRS resource.

6. The apparatus of claim 2, wherein the muting configuration applies to a subset of SL PRS resources within a totality of configured resources.

7. The apparatus of claim 1, wherein the at least one processor is configured to cause the apparatus to transmit signal assistance information to the responder device, the signal assistance information comprising at least the SL PRS transmit power.

8. The apparatus of claim 1, wherein the at least one processor is configured to cause the apparatus to receive a report from the responder device comprising a measurement of a SL PRS RSS metric for adapting the SL PRS transmit power, the SL PRS RSS metric comprising one or more of a reference signal received power (“RSRP”) and a received signal strength indicator (“RSSI”).

9. The apparatus of claim 1, wherein the at least one processor is configured to cause the apparatus to receive, from the responder device, separate RSS measurement reports for adapting the SL PRS transmit power.

10. The apparatus of claim 1, wherein the SL PRS transmit power is adapted from an anchor device and from the responder device within the same SL positioning session.

11. The apparatus of claim 1, wherein the at least one processor is configured to cause the apparatus to determine one or more SL pathloss values with respect to one or more of other anchor nodes and other initiating devices to adapt its SL PRS transmit power.

12. The apparatus of claim 1, wherein the at least one processor is configured to cause the apparatus to adapt the SL PRS transmit power based on a determined zone ID of an initiator device and the responder device.

13. The apparatus of claim 1, wherein the apparatus comprises one or more of a base station, a roadside-unit, an anchor user equipment (“UE”), and a location server, and a responding device may further comprise one or more of a roadside-unit, an anchor node, and other UEs participating in a positioning session.

14. A method for wireless communication, the method comprising:
receiving a configuration for adapting a transmit power of a sidelink (“SL”) positioning reference signal (“PRS”) transmission for a responder device;
receiving a reported received signal strength (“RSS”) measurement from the responder device; and
adapting the SL PRS transmit power for the responder device based on the received configuration and the RSS measurement.

15. An apparatus for wireless communication, comprising:
at least one memory; and
at least one processor coupled with the at least one memory and configured to cause the apparatus to:
receive, from an initiator device, signal assistance information comprising at least a sidelink (“SL”) positioning reference signal (“PRS”) transmit power;
compute the SL PRS transmit power based at least in part on the received signal assistance information and determine an SL PRS received signal strength (“RSS”) measurement; and
transmit a report comprising the SL PRS RSS measurement to the initiator device for adapting the SL PRS transmit power of the initiator device.

16. A processor for wireless communication, comprising:
at least one controller coupled with at least one memory and configured to cause the processor to:
receive a configuration for adapting a transmit power of a sidelink (“SL”) positioning reference signal (“PRS”) transmission for a responder device;
receive a reported received signal strength (“RSS”) measurement from the responder device; and
adapt the SL PRS transmit power for the responder device based on the received configuration and the RSS measurement.

17. The processor of claim 16, wherein the configuration is received from a configuration entity and the configuration comprises at least one of SL PRS transmit power control parameters and a muting configuration.

18. The processor of claim 17, wherein the SL PRS transmit power control parameters comprise one or more of a user equipment (“UE”) configured transmit power, a nominal power, a fractional power loss, an SL pathloss, and a downlink (“DL”) pathloss.

19. The processor of claim 17, wherein the muting configuration is provided based on a relative distance between an anchor device and the responder device.

20. The processor of claim 17, wherein the muting configuration applies to each configured SL PRS resource.
